(19) United States
(12) Patent Application Publication
(10) Pub. No.: US 2017/0274628 A1
(43) Pub. Date: Sep. 28, 2017

(54) TRANSPARENT HEAT-PROTECTION ELEMENT

(71) Applicant: Saint-Gobain Glass France, Courbevoie (FR)

(72) Inventors: Udo Gelderie, Würselen (DE); Norbert Schwankhaus, Baesweiler (DE); David Te Strake, Aachen (DE)

(21) Appl. No.: 15/528,704

(22) PCT Filed: Nov. 24, 2015
(86) PCT No.: PCT/EP2015/077505

§ 371 Date: May 22, 2017

(30) Foreign Application Priority Data
Nov. 24, 2014 (EP) 14194499.1

(51) Int. Cl. B32B 17/06

(52) U.S. Cl. CPC B32B 17/069; B32B 2266/12; B32B 2307/412; B32B 2307/3065

(57) ABSTRACT

A light-permeable heat protection element having a first and a second support member and having an intermediate layer between the first and the second support member. The intermediate layer has a cured alkali silicate gel formed of an aqueous alkali silicate solution and a silicon dioxide compound. The alkali silicate gel of the intermediate layer thereby has a molar ratio of silicon dioxide (SiO₂ to alkali metal oxide (M₂O) greater than 4. Furthermore, the alkali silicate gel has 0.05 to 0.14 weight percent of lithium silicate.

### BACKGROUND OF THE INVENTION

Field of the Invention

The invention relates to the field of fire protection, in particular to a fire-protection glazing with a fire-protection interlayer of a hydrous alkali silicate.

Description of Related Art

A transparent heat-protection element with a protective layer of a cured polysilicate between two glass planes is known, for example, from WO 94/04355. The cured polysilicate is formed from an alkali silicate and at least one curing agent, wherein a molar ratio of silicon dioxide to alkali metal oxide (M₂O) which is larger than 4:1 is set in the polysilicate. The polysilicate is designed as an alkali silicate water glass. The initial mass for the polysilicate/alkali silicate water glass is a flowable mass with a water content of up to 60% and can be poured into the intermediate space between two glass plates. The high water content is retained on curing the mass, and despite this, the polysilicate/alkali silicate water glass has a high intrinsic strength and adhesion to the glass plates. Preferably, a lithium silicate, sodium silicate or potassium silicate or a mixture of these is applied as an alkali silicate, and a sodium oxide, potassium oxide or lithium oxide or a mixture of these is applied as an alkali metal oxide. The content of alkali metal oxide (M₂O) in the form of sodium oxide, potassium oxide or lithium oxide or a mixture of this is maximally 16%.

A tendency to haze can be observed with protective layers of hydrous alkali silicate and silica sol as a curing agent as with WO 94/04355, in particular with time or given unfavourable environmental factors, such as long hot summers with a longer lasting effect of high temperatures, or incorrect use, and a hazing process can be initiated.

A transparent heat-protection element with at least one carrier element and at least one protective layer is disclosed in WO 2009/111897. The protective layer includes a reaction product having an aqueous alkali silicate solution and an aluminum-modified or borate-modified silicon dioxide, in order to increase the ageing resistance of the heat-protection element. The reaction product has a molar ratio of silicon dioxide to alkali metal oxide (M₂O; M=boron, lithium, sodium or potassium) of 4 to 7. The content of alkali metal oxide in the form of sodium oxide, potassium oxide or lithium oxide or a mixture of this is maximally 16%.

### SUMMARY OF THE INVENTION

It is therefore the object of the invention, to provide an alternative heat-protection element, which has a reduced tendency to hazing (opacity) and thus an improved resistance to ageing.

The transparent heat-protection element with a first and with a second carrier element includes an interlayer between the first and the second carrier element. The interlayer includes a cured alkali silicate gel which is formed from an aqueous alkali silicate solution and a silicon dioxide compound. Thereby, the alkali silicate gel of the interlayer has a molar ratio of silicon dioxide (SiO₂) to alkali metal oxide (M₂O) of greater than 4. Moreover, the alkali silicate gel includes 0.05 to 0.14 percent by weight of lithium silicate.

With long-term measurements of the hazing (opacity) of the heat-protection elements with two carrier elements and with an interlayer of a cured alkali silicate gel with a constant molar ratio of silicon dioxide to alkali metal oxide (also indicated as module), it has been found that a metering (metered addition; doping; dosage) of lithium silicate to an essentially lithium-free alkali silicate has a positive effect on the long-term transparency of the intermediate layer, also called interlayer. The effect of the reduction in hazing can thus therefore be attributed exclusively to the metered lithium silicate.

The heat-protection elements were aged at 60° and their haze was measured over time, in order to examine the ageing of heat-protection elements with different meterings of lithium silicate to the alkali silicate gel of the intermediate layer.

The long-term measurements of the haze of heat-protection elements surprisingly show that an increased reduction of the hazing of the heat-protection element as a sign of ageing can be achieved in the region of 0.05 to 0.14% by weight of lithium silicate. A renewed increase of the haze over the course of time could be ascertained with a higher content of lithium silicate. In other words: an over-metering or under-metering of lithium silicate to the alkali silicate gel leads to no or to a less pronounced positive effect upon the ageing resistance of the heat-protection element.

In contrast, the person skilled in the art would expect a further increase of the lithium silicate content to lead to a further improvement of the ageing resistance being able to be achieved, and as disclosed for example in WO 94/04355, would use intermediate layers with a content of up to 16% lithium oxide.

In further embodiment examples, the silicon dioxide compound can include a silica sol, precipitation silicon dioxide, silica gel and/or pyrogenic silicon dioxide, for forming the alkali silicate gel. It is possible for the formation of a homogenous and clear alkali silicate gel to be simplified in this manner, since the silicon dioxide compound can release silicic acid in aqueous solution, the silicic acid being able to function as a curing agent for forming the alkali silicate gel.

The aqueous alkali silicate solution can include a lithium silicate or a mixture of lithium silicate, sodium silicate and/or potassium silicate. The molar ratio of silicon dioxide to alkali metal oxide (module) can be set to a desired value in this manner.

The alkali silicate gel of the interlayer can have a module, for example, of 4.5 to 8, in particular 4.5 to 7, in particular 4.8 to 5.1.

The alkali metal oxide can include a lithium oxide or a mixture of lithium oxide, sodium oxide and/or potassium oxide, for setting the molar ratio of silicon dioxide (SiO₂) to alkali metal oxide (M₂O).

The interlayer can have a content of 30% to 55%, in particular of 37% to 40% of silicon dioxide, by which means the cured alkali silicate gel can be formed as a homogenous alkali silicate water glass.

In other embodiment examples, the interlayer can include up to 60% water. It is possible for a large amount of energy to be able to be absorbed by the interlayer on account of the high thermal capacity of water, and a heating of the heat-protection element can therefore be slowed down. The heat-protection element can moreover achieve a high fire-resistance duration by way of this, since a large quantity of heat can be absorbed for the evaporation process of the water.

The interlayer can include means for reducing the freezing point (means for freezing point reduction), wherein the means for freezing point reduction can include a monofunctional and/or polyfunctional alcohol such as, for example, glycerine, glycol, sugar, diethylene glycol and polyethylene glycol and/or monoethylene glycol.

In further embodiment examples, the fire-protection element can include an edge composite along the edge, between the first and the second carrier element. Thereby, the edge composite and the carrier elements form an intermediate space, which is filled with the interlayer. By way of this, it is possible for the interlayer to be able to be filled into the intermediate space and held in the intermediate space. The cured alkali silicate gel can be arranged up to the edge of the heat-protection element in this manner, and be sealed to the surrounding air with the help of the edge composite. Such a sealing is advantageous, since the alkali silicate gel of the interlayer could undergo undesired reactions with the surrounding air, and could thus accelerate the ageing process of the heat-protection element.

The edge composite can be designed in a two-part manner and includes a spacer (and/or bonding agent) as well as a sealing mass. The spacer, for example, can be arranged at the inner side, and the sealing mass at the outer side. Plastics such as for example butyl polymers—in particular polyisobutylenes—can be considered as spacers, and hybrid structures of a metallic frame and a plastic are also considered. Polysulphide is suitable, for example, as the sealing mass, and other plastics such, as e.g., silicones and polyurethanes with sealing characteristics, are likewise known.

In further embodiment examples, the heat-protection element can include a primer layer between the first and the second carrier element, the primer layer being arranged on at least one of the carrier elements, facing towards the interlayer. The primer layer includes a material whose adhesion onto the interlayer and/or onto at least one of the carrier elements reduces under fire-protection test conditions, in comparison to room temperature conditions.

The term “primer” is to be understood in that the primer layer creates an adhesion between carrier element and the interlayer, the adhesion preventing a detachment of the carrier element and of the interlayer from one another at normal temperatures, for example maximal 50° C., even over long periods of time.

The primer layer can be arranged on that carrier element, which lies at the side facing the fire (inasmuch as this is defined). It is also possible for the primer layer to be arranged on both sides of the interlayer in each case.

The approach of designing the primer layer such that the adhesion deteriorates under conditions prevailing with a fire-protection test is based on the recognition that the carrier element facing the fire can burst and individual fragments can detach, in the case of an intense heating, which is the case under fire test conditions or also in the emergency case. If this is the case, then it should be ensured that the cohesion within the interlayer is greater than the adhesion to the carrier element facing the heat source, so that no gaps are torn into the interlayer when the fragments detach from the carrier element.

The primer layer, for example, can be designed such that its adhesion onto the interlayer significantly reduces at temperatures close to the boiling point of water, i.e. at temperatures of above approx. 80° C. or above approx. 90° C.

A silane, in particular an organofunctional silane, in particular alkyl silane, for example a halogenated, in particular fluorinated and/or chlorinated, alkyl silane can be used as a primer with the present interlayers based on alkali silicate. Alternatively, the primer layer can include a material of the group of waxes, fatty acids, fatty acid derivatives, thermoplastic lacquers, in each case preferably with a softening point or melting point between 70° C. or 80° C. and 150° C.

At least one of the carrier elements can be designed as a glass pane, in particular as a flat glass pane. In other embodiment examples, at least one of the carrier elements can be designed as ceramic glass or specially bent glass. Thermally or possibly chemically prestressed glass panes can be particularly favourable. Transparent carriers based on polymer (for example of polycarbonates or polymethyl methacrylate (PMMA; acrylic glass)), partly crystalline “glasses” (ceramic glasses), borosilicate glasses or composite systems with glass panes and plastic carriers are also considered as alternatives to glass panes based of silicon oxide.

At least one of the carrier elements can be designed as a transparent carrier element.

The heat-protection element can include several interlayers, which are arranged between two carrier elements in each case. In this manner, it is possible for the several interlayers to be able to absorb more energy than a single interlayer. The heat-protection characteristics of the heat-protection element can be improved by way of this.

In further embodiment examples, the heat-protection element can be designed as a fire-protection element. A fire-protection element is characterised by a fire-resistance duration. The fire-resistance or burn-resistance can be considered as the capability of a component of forming an effective barrier against the spreading of flames, smoke and hot gases and/or of preventing the transmission of radiant heat. A fire-resistance duration is defined as a minimum duration in minutes, during which the fire-protection element fulfils certain possibly standardised requirements on testing according to standardised test methods with defined constraints (EN 1364 and EN 1363) and under a certain temperature loading. For example, such standardised requirements are specified, which is to say defined in EN 13505 and permit the classification of fire-protection elements. The fire-resistance duration is thus a measure of the usability of the construction in the case of fire. In other words: the passage of fire through the fire-protection element is prevented, thus a closure of the room or space under fire conditions (EN 1363 and EN 1364) is ensured, during the fire-resistance duration. The fire-protection element additionally to the room closure can yet fulfill further functions, such as heat insulation for example.

Classification times are specified in minutes for each classification, wherein the classification times 10, 15, 20, 30, 45, 60, 90, 120, 180, 240 or 360 are to be used. The fire-resistance duration is thus defined by at least 10 minutes. Generally, a fire-protection element therefore fulfils the respective criteria or requirements (see classification—EN 13501) for the fire resistance duration, for at least 10 minutes. The minimum criterion is thereby the room closure. A fire-protection element must therefore be able to be classified at least as E10.

The alkali silicate gel can have a molar ratio of silicon dioxide to alkali metal oxide (module) of larger than 4. It is also possible for the module of the alkali silicate gel to lie in the range between 4.2 and 6.5.

Likewise the subject-matter of the invention is a method for manufacturing a heat-protection element of the described type.

With the method for manufacturing the heat-protection element, a mixture of aqueous alkali silicate solution and of the silicon dioxide compound is brought into an intermediate space between the first and the second carrier element. The mixture cures in the intermediate space amid the input of energy, into an alkali silicate gel and thus forms the intermediate layer.

### BRIEF DESCRIPTION OF THE DRAWINGS

The subject-matter of the invention is hereinafter described in more detail by way of preferred embodiment examples which are represented in the accompanying drawing. In each case are schematically represented:

FIG. 1 haze development in heat-protection elements over time, for different compositions of an interlayer in a fire-protection element, at 60° C.

### DETAILED DESCRIPTION OF THE INVENTION

Basically, the same or analogous parts in the figure are provided with the same reference numerals.

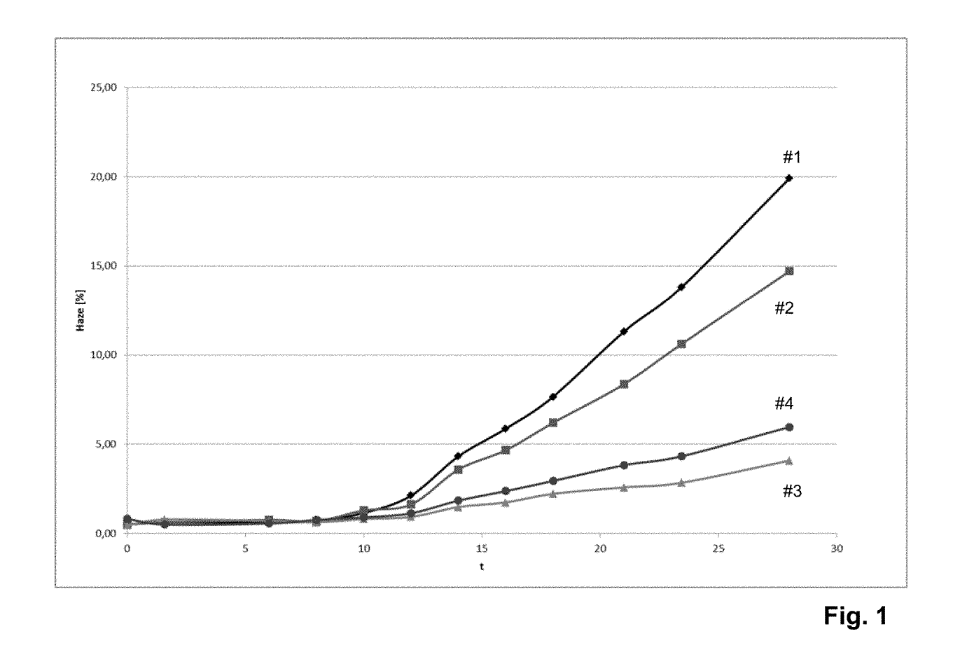

FIG. 1 shows the haze development in heat-protection elements over time, in weeks, for different compositions of an interlayer in a fire-protection element, with storage at 60° C.

With long-term measurements of the haze of the heat-protection elements with two carrier elements and an interlayer of a cured alkali silicate gel with a constant molar ratio of silicon dioxide to alkali metal oxide (also indicated as the module), it has been found that the metering of lithium silicate to an essentially lithium-free alkali silicate has a positive effect on the long-term transparency of the intermediate layer. The effect of the reduction of the hazing can be attributed exclusively to the metered lithium silicate.

The heat-protection elements were aged at a constant temperature of 60° C. and their haze was measured over time, as shows in FIG. 1, in order to examine the ageing of heat-protection elements with different meterings of lithium silicate to an essentially lithium-free alkali silicate gel. A hazing can be initiated and very unfavourable environmental influences can be simulated with the help of such a long-term measurement.

The hazing of the heat-protection element can be specified as a percentage in haze (H). The scatter component of the transmitted light is determined by the haze value. Low haze values correspond to a high transparency and a high haze value entails a hazing of transparent elements.

The following examples serve for illustrating and explaining the invention and are not to be considered as limiting.

The following percentage details concerning the composition of the alkali silicate gel are to be understood as a percentage by weight and relate to the cured alkali silicate gel.

### Example 1 Sample #1

4.5% of monoethylene glycol (MEG) as an agent for reducing the freezing point was added to a hydrous, essentially lithium-free alkali silicate, as a mixture of 56% of an aqueous, essentially lithium-free alkali silicate solution and 39.5% of a precipitation silicon dioxide. The alkali silicate is an essentially pure potassium silicate, which can contain traces of sodium, but has no significant quantities of lithium. The module of the hydrous, essentially lithium-free alkali silicate was set to 5.09. The hydrous alkali silicate is brought into an intermediate space between a first and a second carrier element, said carrier element be designed in each case as a prestressed glass pane. The intermediate space is formed by the two parallel glass panes, and edge composite is formed along the edges of the glass panes. The hydrous, essentially lithium-free alkali silicate with a module of 5.09 and which is introduced into the intermediate space is cured in the intermediate space into an alkali silicate gel. The heat-protection element, which is manufactured in this manner, is known for example from WO 94/04355. The heat-protection element is subjected to a long-term measurement of the hazing at 60° C. The results of the long-term measurement are shown in FIG. 1. The readings of the sample #1, which are characterised by rhombuses (♦) show an increase in the hazing. The haze value is 11.3% after 21 weeks.

### Example 2-Sample #2

In a modified variant, a hydrous, essentially lithium-free alkali silicate according to Example 1 was used, to which however 0.1% (percentage by weight, with respect to the cured alkali silicate gel) of a lithium silicate solution with 2.65% lithium oxide was metered. The module of the hydrous, lithium-containing alkali silicate was set to 5.09, as with Example 1, and all other parameters remain unchanged vis-à-vis Example 1. The respective heat-protection layer was likewise subjected to a long-term measurement of the hazing at 60° C. The results of the long-term measurement are shown in FIG. 1. The readings of the sample #2, which are characterised by squares (▪), show an increase in the hazing. The haze value after 21 weeks is only 8.4% in comparison to sample #1.

### Example 3-Sample #3

In a varying embodiment, a hydrous, essentially lithium-free alkali silicate according to Example 1 (sample #1) was used, to which however 0.2% of the lithium silicate solution with 2.65% lithium dioxide was metered, similarly to Example 2 (sample #2). The module of the hydrous alkali silicate was set to 5.09, as in Example 1 and 2, and all other parameters remain unchanged vis-à-vis Example 1. The respective heat-protection element was likewise subjected to a long-term measurement of the hazing at 60° C. The results of the long-term measurement are shown in FIG. 1. The readings of sample #3, which are characterised by triangles (▴), show a minimal increase in the hazing. The haze value was only 2.6% after 21 weeks.

### Example 4-Sample #4

In a varying embodiment, a hydrous alkali silicate according to Example 3 (sample #3) was used, to which however 0.5% of the lithium silicate solution with 2.65% lithium oxide was metered. The module of the hydrous alkali silicate, as in Example 1, 2 and 3, was set to 5.09, and all other parameters remain unchanged vis-à-vis Example 1. The respective heat-protection element was likewise subjected to a long-term measurement of the hazing at 60° C. The results of the long-term measurement are shown in FIG. 1. The readings of the sample #4, which are characterised by circles (), show a minimal increase in the hazing. The haze value is only 3.8% after 21 weeks.

Overview. The module and the water content of the samples #2-#4 are set to 5.09 and 42% respectively, as with the sample #1. With sample #2, 0.1% (percent by weight) of a lithium silicate solution is metered to an essentially lithium-free alkali silicate. Moreover, with sample #3 0.2% and with sample #4 0.5% of lithium silicate solution are metered to an essentially lithium-free alkali silicate.

The aforementioned compositions for alkali silicate gel are used as an interlayer for the respective heat-protection elements (#1-#4), with which the alkali silicate gel is arranged between a first and a second carrier element of glass. The samples #1-#4 are each subjected to a long-term measurement of the hazing tendency. The temporal course of the hazing at 60° C. and corresponding to the sample numbers (#1 to #4) and compositions is shown in FIG. 1. The respective measurement points are represented by rhomboid for sample #1, by squares for sample #2, by triangles for sample #3 and by circles for sample #4.

The percentage details concerning the composition of the alkali silicate gel of the interlayer relate to the percentage by weight with regard to the total mass of the intermediate layer.

It is clearly evident from FIG. 1 that a metering of lithium silicate to an essentially lithium-free alkaline silicate in small quantities (see for example sample #2) effects a reduction in the hazing. A significantly more pronounced reduction in the hazing can be effected by a further inventive metering of lithium silicate (see sample #3 and #4 in FIG. 1). As is evident from FIG. 1, the haze value after 21 weeks for sample #1 is 11.3%, for sample #2 with a low metering of lithium silicate already only 8.4%, for sample #3 only 2.6% and for sample #4 with a greater metering 3.8%. It is therefore clear that an over-metering of lithium silicate can surprisingly lead to a renewed increase of the haze value.

The long-term measurements of the haze of the heat protection elements, as shown in FIG. 1 show that an increased reduction of the hazing of the heat-protection element as an appearance of ageing can be achieved in the range of 0.05 to 0.14 percent by weight of lithium silicate (samples #3 and #4). A renewed increase of the hazing over the course of time can be ascertained with a higher content of lithium silicate. In other words: an over-metering or under-metering of lithium silicate to alkali silicate gel leads to no or only a lesser pronounced positive effect on the ageing resistance of the heat-protection element.

The alkali silicate gel of the interlayer can include 54% to 59% of aqueous hydrous alkali silicate solution and 35% to 42% of a silicon dioxide compound as well as 0.05% to 0.14% of lithium silicate, for the heat-protection element according to the invention.

1. A transparent heat-protection element with a first and a second carrier element, comprising an interlayer between the first and the second carrier element, wherein the interlayer comprises a cured alkali silicate gel which is formed from an aqueous alkali silicate solution and from a silicon dioxide compound, wherein the alkali silicate gel has a molar ratio of silicon dioxide (SiO₂) to alkali metal oxide (M₂O) of larger than 4,
wherein the alkali silicate gel comprises 0.05 to 0.14 percent by weight of lithium silicate.

2. The transparent heat-protection element according to claim 1, wherein the silicon dioxide compound comprises at least one of a silica sol, precipitation silicon dioxide, silicic gel and pyrogenic silicon dioxide.

3. The transparent heat-protection element according to claim 1, wherein the alkali silicate solution comprises at least one of a lithium silicate, a mixture of lithium silicate, sodium silicate and/or and potassium silicate.

4. The transparent heat-protection element according to claim 1, wherein the alkali metal oxide comprises a lithium oxide or a mixture of lithium oxide, sodium oxide and/or potassium oxide.

5. The transparent heat-protection element according to claim 1, wherein the interlayer comprises a means for reducing the freezing point of the water component.

6. The transparent heat-protection element according to claim 1, wherein the heat-protection element comprises an edge composite along the edges, between the first and the second carrier element, wherein the edge composite and the carrier elements form an intermediate space that is filled with the interlayer.

7. The transparent heat-protection element according to claim 6, wherein the edge composite comprises a spacer and a sealing mass.

8. The transparent heat-protection element according to claim 1, wherein a primer layer of a material whose adhesion onto the interlayer and/or onto at least one of the carrier elements reduces under fire-protection test conditions compared to room temperature conditions, is arranged between the first and the second carrier element.

9. The transparent heat-protection element according to claim 1, wherein at least one of the carrier elements is designed as a prestressed glass pane.

10. The transparent heat-protection element according to claim 1, wherein the heat-protection element comprises several interlayers that are arranged between two carrier elements in each case.

11. The transparent heat-protection element according to claim 1, wherein the heat-protection element is a fire-protection element.

12. A method for manufacturing a transparent heat-protection element according to claim 1, wherein, while using a hydrous alkali silicate, said hydrous alkali silicate being a mixture of the aqueous alkali silicate solution and of the silicon dioxide compound, is brought into an intermediate space between the first and the second carrier element, and is cured in the intermediate space into alkali silicate gel as an interlayer, wherein the molar ratio of silicon dioxide to alkali metal oxide is set to larger than 4 and the alkali silicate gel comprises 0.05 to 0.14% by weight of lithium silicate.
